(19) United States
(12) Patent Application Publication
(10) Pub. No.: US 2016/0292687 A1
(43) Pub. Date: Oct. 6, 2016

(54) VERIFICATION LOCATION DETERMINATION FOR ENTITY PRESENCE CONFIRMATION OF ONLINE PURCHASES

(71) Applicant: EMPIRE TECHNOLOGY DEVELOPMENT LLC, Wilmington, DE (US)

(72) Inventor: Ezekiel KRUGLICK, Poway, CA (US)

(21) Appl. No.: 14/438,223

(22) PCT Filed: Oct. 13, 2014
(86) PCT No.: PCT/US14/60285

§ 371 Date: Apr. 23, 2015

(51) Int. Cl. G06Q 20/40; H04W 4/02; G06Q 20/32

(52) U.S. Cl. CPC G06Q 20/4016; G06Q 20/3224; H04W 4/021

(57) ABSTRACT

Technologies are generally described that relate to verification location determination for entity presence confirmation of online purchases. An example method may include determining whether a first risk level associated with a first candidate transaction is capable of mitigation to a defined level via physical verification of an entity associated with the first candidate transaction, wherein the first candidate transaction is determined to satisfy a defined risk profile. The method may also include, in response to determining that the first risk level associated with the first candidate transaction is capable of the mitigation to the defined level via the physical verification, generating location information indicative of a selected location for the physical verification.

### TECHNICAL FIELD

The subject disclosure relates generally to verification location determination for entity presence confirmation of online purchases.

### BACKGROUND

Unless otherwise indicated herein, the materials described in this section are not prior art to the claims in this application and are not admitted to be prior art by inclusion of this section.

One impediment to online shopping is a lack of security and corresponding fraud that can result. In cases in which a user is online shopping from home, the Internet Protocol (IP) address associated with the home can be captured. However, in cases in which the user is online shopping via a mobile device, often nothing more than knowledge of a credit card number is employed to complete a purchase. In some cases, this may result in refusal of purchases out of an abundance of caution. Likewise, newer electronic payment systems often require a password, forcing a trade-off between increased fraud or refusing legitimate transactions. Security and fraud prevention are commonly identified as a key focus for further development in order to facilitate online shopping via mobile devices.

As described by the Federal Trade Commission in Consumer Sentinel Network Data Book for January-December 2012 (2013), available at http://www.ftc.gov/sites/default/files/documents/reports/consumer-sentinel-network-data-book-january/sentinel-cy2012.pdf, credit card fraud is rampant and resulted in more than five billion dollars in loss in 2012. As also noted in the same publication from the Federal Trade Commission, the median amount of the fraud was approximately $399, and typically occurred over the course of one to three transactions in which no card was physically provided to a merchant. As described in Paul Demery, Online Fraud Costs E-retailers $3.5 Billion in 2012, Internet Retailer (2013), available at https://www.internetretailer.com/2013/03/28/online-fraud-costs-e-retailers-35-billion-2012, of the more than five billion dollars in fraud loss in 2012, more than three billion dollars in loss was the result of online fraud. As also noted in Online Fraud Costs E-retailers $3.5 Billion in 2012, due to suspicion of online fraud, in 2012, payment processors rejected more than seven percent of international orders, and almost three percent of domestic orders.

With regard to online fraud, fraud performed via purchases on mobile devices is one key focus since mobile devices often recycle Internet Protocol (IP) addresses as frequently as every ten minutes. For example, cellular networks may assign new IP addresses at every handoff and additional new IP addresses can be forced by re-setting the data connection. Therefore, the IP addresses from which an online transaction is performed via a mobile device is often difficult to trace.

The above-described fraud scenarios hamper the paradigm shift from traditional shopping at brick and mortar retail stores to online shopping and/or the use of alternate payment systems associated with online shopping. As such, solutions that provide an opportunity to reduce fraud and/or increase allowance of non-fraudulent transactions are a gain for payment processors, merchants, and customers alike.

### SUMMARY

In various, non-limiting embodiments, systems, devices, methods and/or computer-readable storage media that facilitate entity presence of online purchases are described herein.

In some embodiments, methods may include determining, by a device including a processor, whether a first risk level associated with a first candidate transaction is capable of mitigation to a defined level via physical verification of an entity associated with the first candidate transaction, wherein the first candidate transaction is determined to satisfy a defined risk profile. The method may also include, in response to determining that the first risk level associated with the first candidate transaction is capable of the mitigation to the defined level via the physical verification, generating location information indicative of a selected location for the physical verification.

In another embodiment, a computer-readable storage device stores executable instructions that, in response to execution, cause a device including a processor to perform operations. The operations include: receiving information indicative of a candidate transaction having a defined risk level satisfying a defined risk profile; and determining location information representing a selected location for physical verification of an entity associated with the candidate transaction. The operations also include transmitting, to the entity, the location information for the physical verification.

In another embodiment, another method includes: receiving, by a device comprising a processor, information indicative of a candidate transaction having a defined risk level satisfying a defined risk profile; and determining location information representing a selected location for physical verification of an entity associated with the candidate transaction. The method also includes transmitting to the entity the location information for the physical verification.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, various non-limiting embodiments are further described with reference to the accompanying drawings in which:

FIG. 1 illustrates an example block diagram of a system that may facilitate verification location determination for entity presence confirmation of online purchases in accordance with one or more embodiments described herein;

FIG. 2 illustrates an example block diagram of another system that may facilitate verification location determination for entity presence confirmation of online purchases in accordance with one or more embodiments described herein;

FIG. 3 illustrates an example block diagram of another system that may facilitate verification location determination for entity presence confirmation of online purchases in accordance with one or more embodiments described herein;

FIG. 4 illustrates an example block diagram of a payments clearing (PC) system of the system of FIGS. 1, 2 and/or 3, which may facilitate verification location determination for entity presence confirmation of online purchases in accordance with one or more embodiments described herein;

FIG. 5 illustrates an example block diagram of a risk mitigation evaluation component of the PC system of FIGS. 1, 2 and/or 3, which may facilitate verification location determination for entity presence confirmation of online purchases in accordance with one or more embodiments described herein;

FIG. 6 illustrates an example block diagram of a verification location—time determination component of the PC system of FIGS. 1, 2 and/or 3, which may facilitate verification location determination for entity presence confirmation of online purchases in accordance with one or more embodiments described herein;

FIG. 7 illustrates an example block diagram of a flow diagram for operations of an example PC system of the system, which may facilitate verification location determination for entity presence confirmation of online purchases in accordance with one or more embodiments described herein;

FIGS. 8-14 illustrate example flowcharts of methods associated with verification location determination for entity presence confirmation of online purchases in accordance with one or more embodiments described herein; and

FIG. 15 illustrates an example block diagram of a computing device that is arranged for facilitating verification location determination for entity presence confirmation of online purchases in accordance with one or more embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, may be arranged, substituted, combined, separated, and designed in a wide variety of different configurations, all of which are explicitly contemplated herein.

Existing risk assessment systems in a mobile payments gateway evaluate a number of variables, including, but not limited to, a multi-merchant purchase history, IP geo-location, customer website behavior, customer order history and/or device fingerprints. One or more or all of these variables may be entered into an overall fraud-scoring model and mobile payments can be determined to be risky based on the values of the variables. In some cases, legitimate transactions are refused and profits are lost. In other cases, illegitimate transactions are approved. As described herein, the problems associated with online shopping fraud is exacerbated when the transaction is initiated via a mobile device.

In various embodiments described herein, risky transactions are mitigated based on confirmation of the entity via physical verification at a verification location. In various embodiments, verification locations can include, but are not limited to, retail or wholesale or general business establishments, one or more automobiles or automobile locations/services (e.g., connected car, UBER® services or LYFT® services), and/or one or more kiosks, at which verification of one or more physical features of an entity can occur. Any location at which verification of the entity can be performed by a human or device is referred to as a “verification location” as described herein. Accordingly, in some embodiments, verification locations are point of sale locations. In other embodiments, verification locations need not be point of sale locations.

The PC system can determine that a transaction is risky, that the risk can be suitably mitigated via physical verification and determines a verification location for physical verification. An entity associated with attempting or initiating the transaction receives a message from the PC system requesting that the entity provide physical verification at a verification location identified by the PC system. In some cases, the verification location is the nearest approved verification location to the entity at the time of the attempted transaction. In other cases, the verification location is an approved verification location near a geographical region in which the entity may be located during a time period prior to shipment of the product that the entity attempts to purchase. In some cases, multiple verification location options may be identified. Any number of approaches or factors can be taken into account in determining the verification location and/or the acceptable time period for the entity to conveniently confirm the transaction in person. Upon physical verification, the PC system can re-evaluate the transaction to determine if the risk level has been mitigated such that the transaction can be approved. If the transaction can be approved, the PC system transmits to a payment processing device for the transaction a message indicating that the transaction should be approved. In some embodiments, the verification location can be reimbursed or paid a fee for providing the verification service.

One or more embodiments described herein can advantageously provide a system to discriminate between a risky transaction that should be rejected and a risky transaction that should be accepted/authorized. If verifying a transaction includes a confirmation of physical appearance and/or, in some cases, taking a picture of the entity attempting to make the transaction, especially since many verification locations now employ devices that have cameras, one may reason that a thief is less likely to attempt physical verification. Thus, a single physical verification may help to validate a change in behavior detected by the system that might otherwise result in multiple rejections of valid purchase attempts. As also noted in Online Fraud Costs E-retailers $3.5 Billion in 2012, rejected mobile payments and accompanying fraud account for a sizeable percentage of mobile web transactions, and there is huge financial reward in being able to sample and resolve the truth of the risk signals generated from an attempted transaction.

Accordingly, one or more embodiments described herein may advantageously reduce the likelihood of mobile device online shopping fraud, and corresponding multi-billion dollars in fraud loss incurred by businesses. Additionally, one or more embodiments described herein may advantageously improve the ability for users to perform legitimate domestic and international mobile device online shopping without significant risk that the legitimate transactions will be refused, and the resultant uncertainty and unease that results for users.

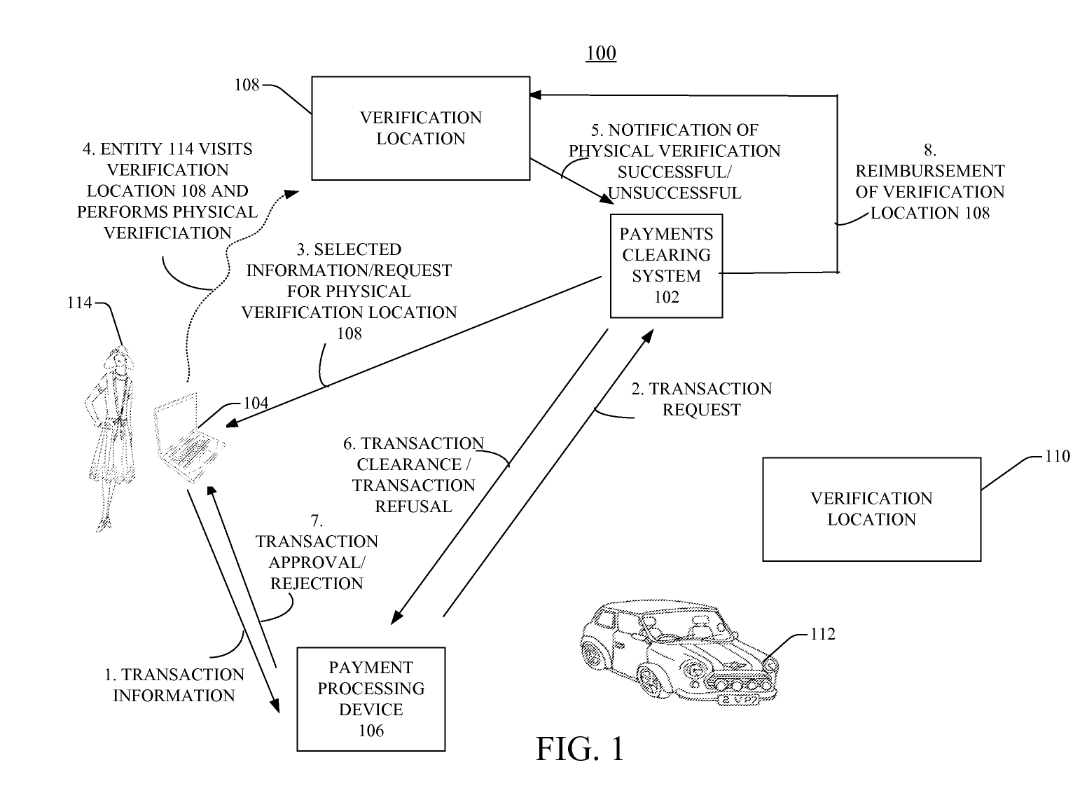

Turning now to the drawings, FIG. 1 illustrates an example block diagram of a system 100 that may facilitate verification location determination for entity presence confirmation of online purchases in accordance with one or more embodiments described herein. System 100 includes a PC system 102, a device 104, a payment processing device 106 and/or verification locations 108, 110, 112. In various embodiments, one or more of PC system 102, device 104, payment processing device 106 and/or verification locations 108, 110, 112 may be electrically and/or communicatively coupled to one another to perform one or more functions of system 100. As shown, an entity 114 can be associated with and/or control device 104.

Device 104 may be any number of different types of devices that may be able to initiate an online shopping transaction over the Internet, either via a wired or wireless channel. In various embodiments, device 104 may be mobile or stationary. By way of example, but not limitation, device 104 may be a cellular telephone, laptop, tablet, personal computer (PC) or any number of other stationary or mobile devices that can initiate and/or process an online shopping transaction.

Device 104 may be controlled by and/or associated with entity 114, which may enter information into device 104 to initiate and/or complete online shopping via device 104. For example, entity 114 can be associated with a particular credit card employed at device 104 to purchase a product or service. As such, the name of entity 114 can be the name of the party on the credit card for the transaction completed for device 104. The transaction information can be transmitted from device 104 to payment processing device 106 (operation 1).

Payment processing device 106 may be associated with approving and/or processing the online purchase. As such, prior to approval of the online shopping purchase via device 104, payment processing device 106 may transmit an incoming transaction request to PC system 102 to determine whether to accept and process the online purchase (operation 2). In some embodiments, the transaction information and/or transaction request can include details of the attempted transaction including, but not limited to, the name of entity 114, the credit card number employed by entity 114, an amount of a purchase and/or a date of the purchase. In some embodiments, the transaction can be an online shopping transaction.

In various instances in which the online shopping transaction is deemed by PC system 102 to have a risk profile that indicates a risk level of fraud greater than a particular defined threshold, or, in some embodiments, has a defined number of characteristics indicating significant or non-negligible risk of fraud, PC system 102 may request that entity 114 physically present him or herself in person at one of verification locations 108, 110, 112 to verify an appearance or other feature of entity 114. In various embodiments, PC system 102 can evaluate any number of factors including IP geo-location, multi-merchant purchase history (for determination of purchase velocity), entity behavior on website associated with transaction, entity order history and/or device fingerprints. In some embodiments, PC system 102 may evaluate the risk profile of the online shopping purchase based on the entity identity, mobile device information, and/or parameters of the online shopping purchase. For example, in various embodiments, one or more of the following parameters may be considered by PC system 102 to determine whether the online shopping purchase has a risk profile that indicates physical verification of entity 114 should occur prior to approval of the online transaction by payment processing device 106. For example, the factors may include, but are not limited to, location of mobile device 106 relative to the typical location of mobile device 106, amount of the online purchase, history of repeat online transactions, history of fraud associated with mobile device 106. In some embodiments, factors can include a multi-merchant purchase history, which can be employed to determine purchase velocity for an entity; IP geo-location, customer web site behavior, customer order history, and/or device fingerprints.

In some embodiments, prior to determining whether to transmit a request for physical verification of entity 114, PC system 102 determines whether the risk profile of the transaction is likely to be suitably reduced to a level that permits or allows the transaction to be approved. If the risk level cannot be suitably mitigated, and the transaction would be deemed too risky even with successful physical verification, in some embodiments, PC system 102 generates a refusal/rejection of the transaction request without requesting any physical verification of entity 114.

If PC system 102 determines that physical verification should be performed, PC system 102 may identify one of several verification locations 108, 110, 112 at which entity 114 may go to physically verify the identity of entity 114 to a merchant of, or computerized device at, the selected one of the verification locations 108, 110, 112. In some embodiments, PC system 102 may transmit information describing and/or identifying a selected verification location to which entity 114 should visit and perform verification (operation 3). The information may go directly to device 104 as operation 3 or may be delivered via payment processing device 106.

PC system 102 may determine the selected verification location based on any number of different methods. In some embodiments, PC system 102 determines the location of the selected verification location based on the location that is nearest device 104 at time of receipt of transaction request from payment processing device 106. For example, as shown in FIG. 1, PC system 102 may determine that verification location 108 is geographically closer to device 104 than verification locations 110, 112 at the time that device 104 initiates online shopping transaction (and correspondingly, the time that payment processing device 106 transmits transaction request to PC system 102).

In the embodiment shown, an example set of verification locations are illustrated. Specifically, verification locations 108, 110, 112 located in various geographical areas within a region (e.g., city, country, city block) are shown. In other embodiments, any number of verification locations can be provided in system 100 and/or selected by PC system 102 as a verification location to which entity 114 can physically verify.

Verification locations 108, 110, 112 may be any locations at which a merchant or verification device is located that may generate information indicating that entity 114 does or does not possess features (which may include items) stored, described, shown or otherwise indicated for entity 114. Verification locations 108, 110, 112 may be a mobile location such as that shown at verification location 112 (e.g., a vehicle that provides UBER® services or LYFT® services) or stationary such as that shown at the newsstand at verification location 108 or the music store at verification location 110.

In some embodiments, verification locations 108, 110, 112 may include human merchants capable of providing verification via visual or audio inspection of entity 114. In some embodiments, verification locations 108, 110, 112 may include verification devices capable of providing verification via imaging or audio processing regarding sound emitted from entity 114 (or audio recordation of sound emitted from entity 114) and comparison with stored, described, shown or otherwise indicated features of entity 114 or the like may be performed at the verification location or within the payment network. As such, verification devices may be human merchant inspectors and/or automated, computerized devices having processors and designed to perform verification functions, in various different embodiments. As shown in FIG. 1, verification location 108 is a newsstand, verification location 110 is a music store and verification location 112 is an automobile driven by a human that may verify the features of entity 114 and/or having a computerized device that may perform verification of designated features of entity 114.

Various different features that may be associated with entity 114 may be shown, described or otherwise indicated on an approved verification record that may be provided by entity 114 at the verification locations 108, 110, 112 (e.g., driver license, passport, credit card) in some embodiments. The approved verification document can be compared with entity 114 to confirm that entity 114 is the same entity as that described in the approved verification documents. In some embodiments, in lieu of or in addition an approved verification document, information describing or illustrating one or more features of entity 114 may be stored at a verification device at verification locations 108, 110, 112 and/or otherwise accessed by a verification device at verification locations 108, 110, 112 from a repository (e.g., accessed over a network at verification locations 108, 110, 112).

In some embodiments, features of entity 114 that may be verified include general physical appearance (e.g., facial features, height, weight, hair color, eye color) and/or voice sound. In some embodiments, features of entity 114 may be those that may be confirmed via use of additional verification devices such as retina scan or fingerprint verification devices. Any number of different features of entity 114 may be verified as determined by PC system 102 and/or the verification device available or in use at the selected one of verification locations 108, 110, 112. As such, the information verified and/or the type of device that may be used to perform the verification can vary from one verification location to another verification location.

Accordingly, system 100 may be a system that may provide physical verification of an entity associated with a transaction performed via device 104 to reduce the likelihood of online shopping fraud via device 104. Entity 114 can visit verification location 108, which was selected by PC system 102, and present itself for verification of one or more physical features of entity 114 by a merchant and/or verification device at verification location 108 (step 4). In the embodiment shown, a cashier or owner of the newsstand at verification location 108 can visually confirm one or more features of entity 114, for example.

Upon successful physical verification, verification location 108 transmits a notification to PC system 102 that the verification was successful (operation 5). In some embodiments, successful physical verification can include, but is not limited to, the merchant or verification device confirming that entity 114 has the features (or, in some embodiments, one or more of the features) described or shown on the approved document, stored at verification location 108 and/or accessed at verification location 108.

PC system 102 may re-evaluate whether the risk level associated with the risk profile of the transaction request is such that the transaction has been suitably de-risked and should be approved. If PC system 102 determines that the transaction should be approved, PC system 102 may generate a transaction clearance message indicating that the transaction has been cleared/approved by PC system 102 (operation 6). PC system 102 may transmit the transaction clearance message to payment processing device 106. Payment processing device 106 may then proceed with approval and processing of the payment information provided at or via device 104 (operation 7).

In embodiments in which PC system 102 determines that the transaction should not be cleared/approved, PC system 102 may generate a transaction refusal message (operation 6). The transaction refusal message may be transmitted from PC system 102 to payment processing device 106. Payment processing device 106 may then proceed with rejection of the attempted online shopping purchase (operation 7).

In some embodiments, the merchant and/or verification location that provided the verification service may obtain a reimbursement or other compensation for performing the verification of entity 114 (operation 8). In embodiments in which the selected verification location generates information indicative of successful physical verification of entity 114 in the case of a fraudulent transaction (which may be later determined to be the case), PC system 102 may determine whether point of the sale location will continue to be an approved verification location for physical verification. For example, after a defined number or a defined set of characteristics (e.g., amount of transaction) indicated as successfully verified that are indeed fraudulent, PC system 102 may remove verification location or otherwise penalize verification location (e.g., no reimbursement, verification location pays for the amount of goods/services fraudulently obtained by entity 114) or generate a message that may be provided to law enforcement or the like.

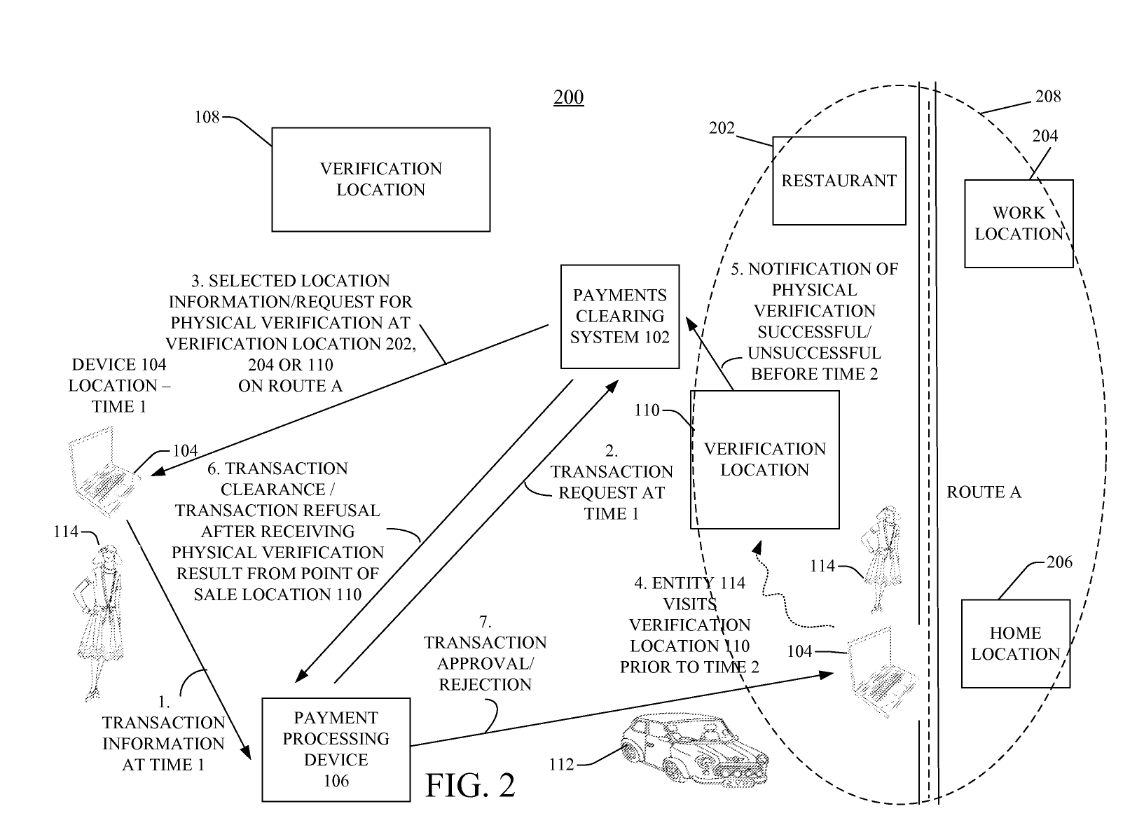

FIG. 2 illustrates an example block diagram of another system that may facilitate verification location determination for entity presence confirmation of online purchases in accordance with one or more embodiments described herein. Repetitive description of like elements employed in respective embodiments of systems and/or apparatus described herein are omitted for sake of brevity.

In some embodiments, responsive to a determination that a transaction has a risk profile that warrants a request for entity 114 to perform a verification, PC system 102 can determine the verification location based on identifying verification locations that are within a defined vicinity of or along a path/route previously-traveled by, or predicted for, entity 114.

By way of example, but not limitation, PC system 102 may identify that Route A has been or is often traveled by entity 114. For example, as shown, route A may be or include the path along which entity 114 has a home location 206, a work location 204 and that includes a restaurant 202, which PC system 102 determines has been frequented by entity 114 in the past. Home location 206, work location 204 and/or restaurant 202 may be information stored at PC system 102 in some embodiments. In other embodiments, home location 206, work location 204 and/or restaurant 202 may be retrieved by PC system 102 from a database (not shown) that may include biographical information, historical/predicted path of travel information or information indicating locations at which devices associated with entities have registered or been located. These locations can be evaluated by PC system 102 to determine whether one or more of such convenient locations may be selected by PC system 102 for verification by an entity.

As shown in FIG. 2, device 104 may initiate an online shopping purchase at time 1. PC system 102 may determine that shipment and/or delivery of the goods/services requested by device 104 will not be provided until time 2. As such, PC system 102 may determine a geographical area at which entity 114 may conveniently provide physical verification based on historical, biographical or other information indicating that entity 114 is likely to be in the defined area during the time period bounded by time 1 and time 2. For example, the geographical area may be area 208 in some embodiments.

By way of example, but not limitation, in one embodiment, PC system 102 may evaluate historical and/or biographical information about device 104 to determine that entity 114 typically travels along route A within the defined time period bounded by time 1 and time 2. Accordingly, PC system 102 may determine that entity 114 of device 104 may provide physical verification at verification locations 202, 204, 110 between time 1 and time 2, and inform entity 114 of the request for verification and the acceptable time during which verification can be performed. In the example shown in FIG. 2, entity 114 successfully provides physical verification at verification location 110 within geographical area 208. PC system 102 transmits a message to payment processing device 106 to accept the transaction and payment processing device 106 processes and/or accepts the transaction.

In some embodiments, although not shown in FIG. 2, PC system 102 determines the location that is near a geographical region in which entity 114 is located during a time period prior to delivery/shipment of the product/service to entity 114. As such, in this embodiment, the time period may be the time period from time of receipt of the transaction request until time of estimated shipment/delivery/provisioning to entity 114 so as to obtain physical verification at any point in time prior to shipment/delivery/provisioning of the good/service to entity 114.

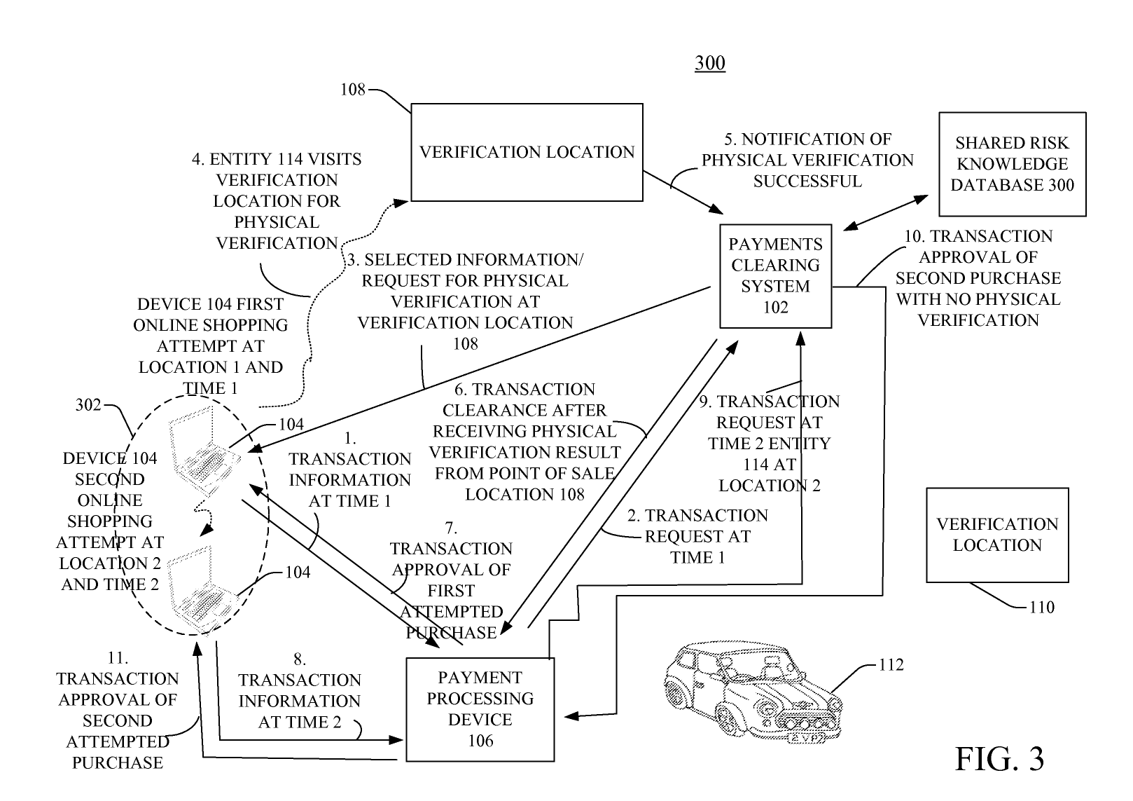

FIG. 3 illustrates an example block diagram of another system that may facilitate verification location determination for entity presence confirmation of online purchases in accordance with one or more embodiments described herein. Repetitive description of like elements employed in respective embodiments of systems and/or apparatus described herein are omitted for sake of brevity.

In the embodiment shown, device 104 initiates a first online shopping attempt at or near location 1 at time 1. For example, location 1 can be a ROSETTA STONE® kiosk in an airport. PC system 102 may deem the transaction as having a risk profile that indicates verification should be performed by the entity associated with the transaction. In some embodiments, PC system 102 can select verification location 108 for physical confirmation of entity 114 and can subsequently receive notification of successful physical verification from verification location 108.

Entity 114 may then initiate a second online shopping attempt at location 2 at time 2. In various embodiments, locations 1 and 2 are within a defined geographical area 302 and/or a defined distance relative to one another and times 1 and 2 are within a defined time period relative to one another. For example, locations 1 and 2 can be within 50 feet of one another while times 1 and 2 can be within one hour of one another. The acceptable distances between locations 1 and 2 and/or times 1 and 2 can vary. Acceptable locations and/or times can also be dictated by a previous shopping pattern of the entity.

PC system 102 can determine that the distance between locations 1 and 2 and the time between times 1 and 2 result in a likelihood greater than or at least equal to a defined threshold that the same entity 114 that has been approved at location 1 for the transaction initiated at time 1 is the same entity 114 at location 2 and time 2. Based on the previous physical verification of entity 114 for the transaction initiated at location 1, PC system 102 may approve the second attempted transaction without repeating physical verification of entity 114. Payment processing device 106 may then proceed with approval and processing of the payment information provided at or via device 104 at time 2. In various embodiments, any number of subsequent transactions may be approved within a joint defined distance and defined time of location 1, time 1. Accordingly, PC system 102 may intelligently determine whether a likelihood of fraud is low enough so as to not overly inconvenience entity 114 with repeated requests for physical verification should entity 114 have a first successful physical verification and subsequent transactions near in time and location of the first transaction. Accordingly, shopping at mall or airport stores near in location and time with one another may be facilitated without repeated physical verifications.

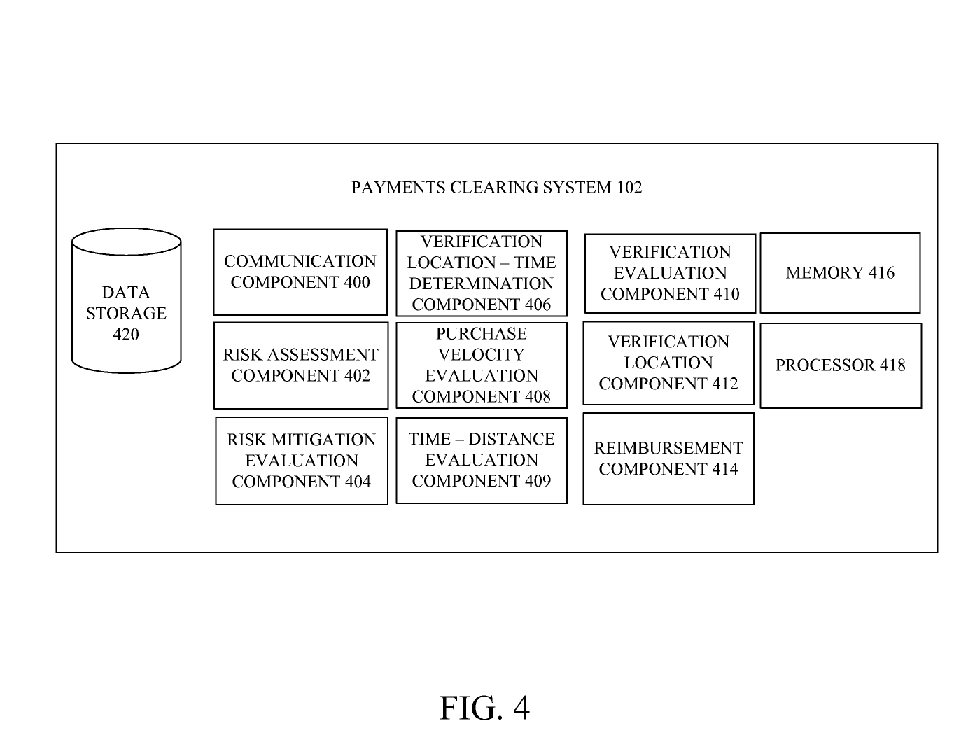

Various embodiments of structure and/or functionality of PC system 102 will be described in greater detail with reference to FIGS. 4, 5, 6 and 7. Repetitive description of like elements employed in respective embodiments of systems and/or apparatus described herein are omitted for sake of brevity.

Turning first to FIG. 4, illustrated is an example block diagram of the PC system of the system of FIGS. 1, 2 and/or 3, which may facilitate verification location determination for entity presence confirmation of online purchases in accordance with one or more embodiments described herein. In one embodiment, PC system 102 may include a communication component 400, a risk assessment component 402, a risk mitigation evaluation component 404, a verification location—time determination component 406, a purchase velocity evaluation component 408, a time—distance evalution component 409, a verification evaluation component 410, a verification location evaluation component 412, a reimbursement 414, a memory 416, a processor 418 and/or a data storage 420. In various embodiments, one or more of communication component 400, risk assessment component 402, risk mitigation evaluation component 404, verification location—time determination component 406, purchase velocity evaluation component 408, time—distance evaluation component 409, verification evaluation component 410, verification location evaluation component 412, reimbursement 414, memory 416, processor 418 and/or data storage 420 may be electrically and/or communicatively coupled to one another to perform one or more functions of PC system 102.

Communication component 400 can transmit and/or receive information from and/or to PC system 102. For example, in various embodiments, communication component 400 can receive an incoming transaction request indicative of details of an attempted transaction by an entity associated with a device (with reference to FIGS. 1, 2 and/or 3, device 104).

Risk assessment component 402 can determine whether the incoming transaction request has one or more different characteristics that result in the incoming transaction having a risk profile that indicates physical verification of the transaction should be performed. Risk assessment component 402 can employ any number of factors to make such determination including, but not limited to, determining that the incoming transaction is originating from a device in a location different from the typical location in which the device is located, the entity initiating the transaction, the purchase history of the entity, the purchase velocity of the entity or any number of other factors. The risk assessment component 402 may be in communication with additional data storages or components not shown here to perform the described steps.

In some embodiments, risk assessment component 402 can generate a calculation that indicates the level of risk of the transaction. The level of risk can be compared to a defined threshold that can be pre-programmed at or accessed by PC system 102 and/or changed from time to time to reflect different sensitivity to risk that the provider of the good or services associated with the transaction may have. The sensitivity can change or be changed based on any number of factors including, but not limited to, time of year (e.g., holiday season versus non-holiday season), time of week (e.g., weekend versus weekday), geographical location from which the incoming transaction originates, amount of the transaction, purchase velocity (e.g., the frequency and/or amount of purchases over time) or the like. The threshold may be adjusted based on the relative inconvenience of verifications proposed by verification location component 412.

After risk assessment component 402 receives information after physical verification of the entity, risk assessment component 402 can perform another assessment to determine whether the transaction should be approved. In some embodiments, the physical verification is successful and PC system 102 outputs a message to payment processing device to approve and/or process the transaction.

However, in some embodiments, the transaction is not approved. For example, the entity may not have performed physical verification as required by PC system 102. As another example, a physical verification may be attempted but fail since the physical features of the entity may differ from those of the authorized features of the entity. As yet another example, in some embodiments, a physical verification can be performed but the picture or other feature of the entity is ambiguous and/or slightly distinct from the entity and the merchant or device of the verification location performing the physical verification cannot successful confirm that the entity is the entity associated with the approved document or information. In this case, the risk assessment component 402 may reject a transaction notwithstanding the entity has performed an attempted physical verification as requested by PC system 102.

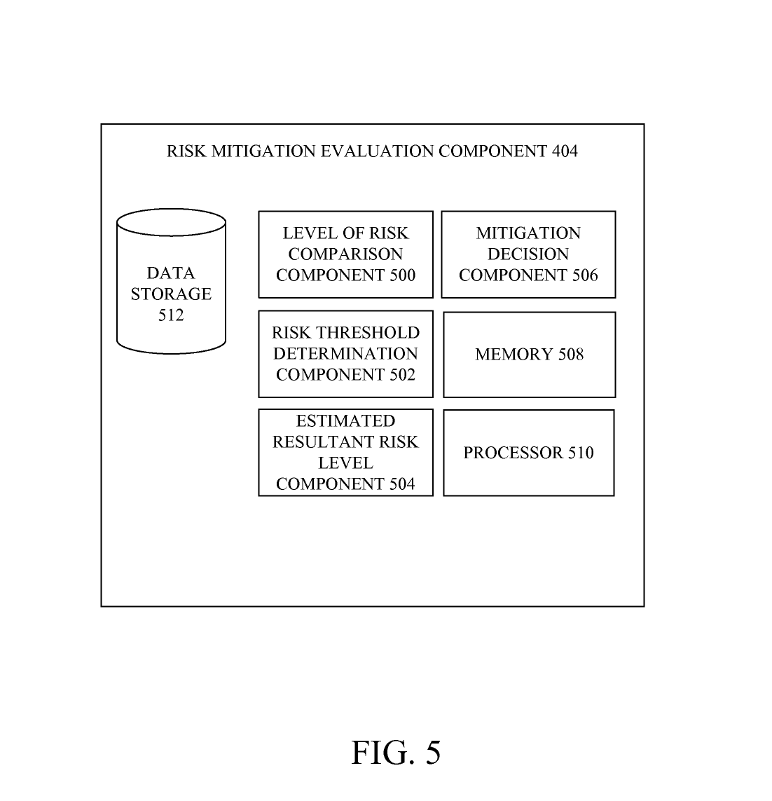

In some embodiments, PC system 102 evaluates the risk mitigation likelihood of a successful physical verification prior to requesting the physical verification. Risk mitigation evaluation component 404 can determine the risk mitigation likelihood of a successful physical verification. The structure and/or functionality of risk mitigation evaluation component 404 can be described in greater detail with reference to FIG. 5. FIG. 5 illustrates an example block diagram of a risk mitigation evaluation component of the PC system of FIGS. 1, 2 and/or 3, which may facilitate verification location determination for entity presence confirmation of online purchases in accordance with one or more embodiments described herein. Repetitive description of like elements employed in respective embodiments of systems and/or apparatus described herein are omitted for sake of brevity.

As shown, risk mitigation evaluation component may include level of a risk comparison component 500, a risk threshold determination component 502, an estimated resultant risk level component 504, a mitigation decision component 506, a memory 508, a processor 510 and/or a data storage 512. In various embodiments, one or more of level of risk comparison component 500, risk threshold determination component 502, estimated resultant risk level component 504, mitigation decision component 506, memory 508, processor 510 and/or data storage 512 may be electrically and/or communicatively coupled to one another to perform one or more functions of risk mitigation evaluation component 404.

Generally, risk mitigation evaluation component 404 can determine whether physical verification of the incoming transaction is likely to reduce the level of risk of the transaction to a level that would allow verification evaluation 412 of FIG. 4 to authorize the transaction for acceptance. In embodiments in which the incoming transaction would still be deemed to have a risk level greater than that accepted for authorization notwithstanding a physical verification is performed, risk mitigation evaluation component 404 can determine such information and inform risk assessment component 402. Risk assessment component 402 can immediately, in some embodiments, issue a message refusing the transaction without resort to physical verification in these instances.

As such, in some embodiments, risk mitigation evaluation component 404 can be employed to determine whether there is any appreciable benefit to physical verification given the potential inconvenience to the entity of requiring physical verification. In other embodiments, risk mitigation evaluation component 404 is not employed and transactions identified as having a level of risk that would not be authorized are automatically sent to verification location—time determination component 412 for physical verification processing.

Turning to FIG. 5, level of risk comparison component 500 can compare the level of risk of an incoming transaction with a defined threshold selected by risk threshold determination component 502. Level of risk comparison component 500 can compare the level of risk identified by risk assessor component 402 with the threshold to determine the extent of the risk associated with the transaction. In various embodiments, the risk threshold employed for the evaluation can differ based on the preference of the merchant associated with providing the goods or services that are the subject of the transaction, based on the entity, based on the time of year or based on any number of factors.

Estimated resultant risk level component 504 can generate an estimate of the reduction in the level of risk associated with the transaction and estimate the resultant level of risk should the entity associated with the transaction undergo successful physical verification.

Mitigation decision component 506 can determine whether the estimated resultant level of risk after a physical verification is less than or equal to that needed for PC system 102 to accept/authorize the incoming transaction and/or if the incoming transaction would still have a level of risk too high to authorize the transaction even if the entity underwent successful physical verification. In some embodiments, mitigation decision component 506 can make a decision based on differentiation between a risky transaction attempted by an entity that cannot do physical verification because there are no verification locations within a defined proximity of entity (or within the defined proximity of a location of entity in the future) versus a risky transaction attempted by an entity in which verification locations are conveniently located to entity. Different thresholds can be set by risk threshold determination component 502 for the two different scenarios. For example, if a verification location cannot be easily accessed by the entity, the level for suitable mitigation of the risk level for authorization of the transaction can be more tolerant/less stringent than the required level of mitigation of the risk level for authorization of the transaction if verification locations are easily accessible to the entity. In some embodiments, the requirement for the physical verification (or the acceptable risk level for approval of the transaction) can be stronger if a verification location is easily accessible than for a scenario in which the verification location is not easily accessible.

Memory 508 can be a computer-readable storage medium storing computer-executable instructions and/or information for performing the functions described herein with reference to risk mitigation evaluation component 404 (or any component of risk mitigation evaluation component 404). For example, memory 508 can store computer-executable instructions that can be executed by processor 510 to perform communication, or any other functions of risk mitigation evaluation component 404. Processor 510 can perform one or more of the functions described herein with reference to risk mitigation evaluation component 404 (or any component of risk mitigation evaluation component 404). Data storage 512 can be configured to store information accessed by, received by and/or processed by risk mitigation evaluation component 404 (or any component of risk mitigation evaluation component 404) including, but not limited to, risk level thresholds for particular merchants, risk level thresholds for particular entities or devices, previous mitigation decisions, algorithms for computing estimated resultant risk post-physical verification or the like.

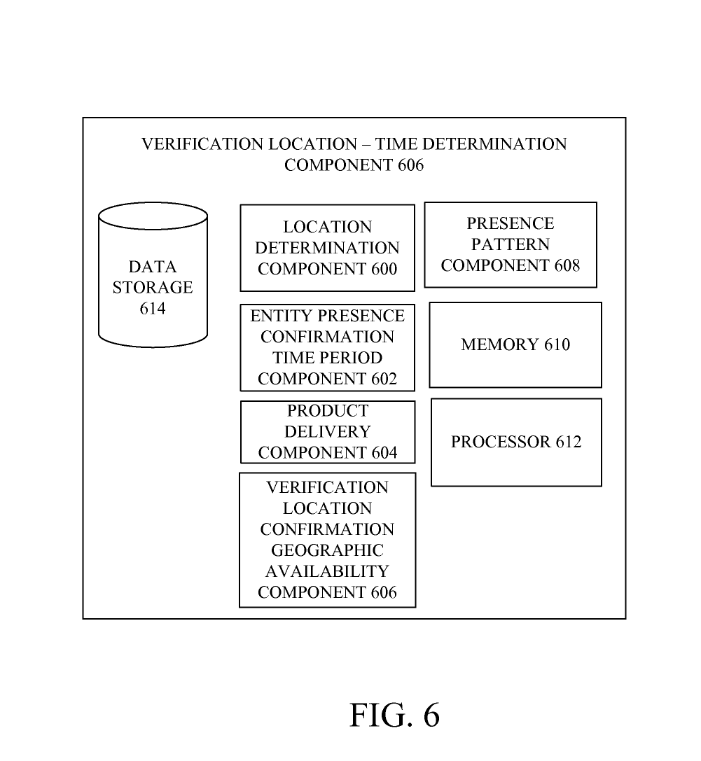

Turning back to FIG. 4, PC system 102 includes verification location—time determination component 406. The structure and/or functionality of one embodiment of verification location—time determination component 406 will be described in greater detail with reference to FIG. 6. FIG. 6 illustrates an example block diagram of a verification location—time determination component of the PC system of FIGS. 1, 2 and/or 3, which may facilitate verification location determination for entity presence confirmation of online purchases in accordance with one or more embodiments described herein. Repetitive description of like elements employed in respective embodiments of systems and/or apparatus described herein are omitted for sake of brevity.

As shown, verification location—time determination component 406 may include a location determination component 600, an entity presence confirmation time period component 602, a product delivery component 604, a verification location confirmation geographic availability component 606, a presence pattern component 608, a memory 610, a processor 612 and/or a data storage 614. In various embodiments, one or more of location determination component 600, entity presence confirmation time period component 602, product delivery component 604, verification location confirmation geographic availability component 606, presence pattern component 608, memory 610, processor 612 and/or data storage 614 may be electrically and/or communicatively coupled to one another to perform one or more functions of verification location—time determination component 406.

Location determination component 600 can select one or more suitable verification locations for physical verification by the entity. Location determination component 600 can employ any number of different techniques for selecting a verification location. By way of example, but not limitation, location determination component 600 can employ predictive analytics to predict the path of travel of the entity. As an illustration of such predictive analytics, many Android phone users may have noticed that after a long trip (e.g., a trip involving air travel), the Google Now service can check the place of an overnight stay to determine if the location appears to be a hotel and, if so, can offer directions back to the hotel location as the user visits locations during the trip. The offers of directions back to the hotel then cease once the user has an overnight stay elsewhere or travels again (such as back to the home of the user). Another example from Google Now is that Google Now attempts to determine the work and home locations of a user from location patterns. The service offers to name the locations and offers directions to home or work locations based on the time of day. In some embodiments, location determination component 600 can employ predictive analytics to predict a future location visit based on a previous location visited even when the future location has not previously been visited by the user.

Thus, in some embodiments, one or more aspects of predictive analytics may be used by location determination component 600 to find a verification location that is nearest an entity, or that is predicted to be near a future (as opposed to the current) location of the entity. As an example, if an entity has walked to lunch from the office, location determination component 600 may select a verification location for physical verification that is near the path back to the office of the entity, allowing the entity to add perhaps just a few steps to divert to a verification location and verify the transaction.

In some embodiments, location determination component 600 can employ predictive analysis based on hidden Markov models. For example, in some embodiments, location determination component 600 can generate information indicative of an internal state model of what activity an entity is doing and thus what activity the entity may intend to do next. Such internal state information may be used to provide an entity a way to confirm the findings of the model and/or to enhance the convenience of physical verification. In one example, location determination component 600 can generate numerous options for verification locations, and such options can be displayed for the entity. As such, the entity is provided the opportunity to confirm the anticipated activity (e.g., returning to the office within 30 minutes, headed back to the hotel, need to get gas soon). In some cases, the prediction by location determination component 600 is approximate, such as when multiple gas stations or stores along a path can serve as verification locations and thereby satisfy the need for physical verification. Such planning may make entity physical verification very convenient.

In some embodiments, the predictive analysis is based on the location of the entity and/or location and direction of travel. In other embodiments, the predictive analysis can be based on previously-known live, work, hotel and/or other details. For example, predictive analysis can indicate a first one or more verification locations if the entity is purchasing from a device while near the home of the entity while predictive analysis can indicate a second one or more verification locations if the entity is purchasing from a device while near a particular hotel (e.g., if the entity is traveling). Predictive analysis may be based on many different forms of data including historical user data, data of other users, and information about the world such as travel maps, location types, knowledge of automotive fuel range, and so on.

Location determination component 600 can cause information about the one or more selected verification locations to be transmitted to the entity (in some embodiments, along with an instruction or request to perform physical verification) based on any number of different scenarios and/or factors.

In some embodiments, location determination component 600 can consider and/or determine the amount of time that the entity has before having to do the verification based on information generated by product delivery component 604. Product delivery component 604 can generate information indicative of the delivery of the product and/or service to the entity and/or information indicative of a time period during which an entity has to successfully complete physical verification based on the anticipated product and/or service delivery date/time. As such, if a shipment of merchandise that is the subject of the attempted transaction will not occur for at least 24 hours, product delivery component 604 can generate information indicating that the entity has at least 24 hours to perform the physical verification. In this case, location determination component 600 can select verification locations that will be nearest and/or otherwise most convenient to entity for physical verification over the 24 hours after the transaction was initiated.

By contrast, if product delivery component 604 determines that there is a need for physical verification in the next 30 minutes because the merchandise is scheduled for immediate shipment, product delivery component 604 can generate information indicating that the entity should provide physical confirmation in the next 30 minutes. Location determination component 600 can then identify one or more verification locations located near and/or otherwise convenient to the current location of entity and/or located in areas that entity can reach in the next 30 minutes.

In this regard, the location identified for the verification locations can be at locations that will be near the entity at a later time (as opposed to locations that are near the current location of the entity). In some embodiments, the use of physical verification may be opportunistic. For example, PC system 102 may use mapping databases to find potential verification locations at which physical verification can be performed by an entity, and may be more inclined to request physical verification if the verification location is closer to the entity than farther from the entity. For example, an entity online shopping in an airport gate area may need to travel no more than a few dozen feet to perform physical verification at the neighboring eatery while an entity using a device from a bus on the highway between cities may not have such a convenient option and so PC system 102 may be less likely to request physical verification.

Further, in some embodiments in which a verification location is not conveniently located to the entity, an attempted transaction may be placed on hiatus/on hold until verification can be performed. In some embodiments, one or more notifications to the entity requesting verification and/or identifying a selected verification location can be transmitted or initiated by PC system 102 when the entity becomes near an opportune verification location that can provide physical verification. For example, this allows an entity to fit a physical verification visit into a normal day, perhaps physically verifying an attempted transaction during the lunch of the entity, for a purchase attempted earlier that morning. This provides an entity with both high confidence and easy convenience.

Verification location confirmation geographic availability component 606 can determine whether the geographic location of the entity and/or device from which the incoming transaction originated is within a defined proximity of any verification locations. For example, in some embodiments, verification location confirmation geographic availability component 606 can determine that an entity or device associated with an incoming transaction is on a cruise ship without authorized verification locations or on an airplane without authorized verification locations and unable to perform physical verification. Verification location confirmation geographic availability component 606 can generate a message to verification location—time determination component 606 when verification locations are detected in the vicinity of the entity and the entity can perform physical verification.

In some embodiments in which the entity is located in a geographic region in which physical verification cannot be performed, verification location confirmation geographic availability component 606 can generate information instructing PC system 102 to hold the instruction to perform physical verification (instead of sending the instruction to the entity upon receipt of the incoming transaction) until the entity (or device associated with the entity and from which the incoming transaction originated) is within proximity to one or more verification locations at which physical verification can be performed.

Presence pattern component 608 can determine the locations frequented by an entity in the past (e.g., home address, business address, verification locations previously visited along a route between the home address and the business address). Presence pattern component 608 can output such information to location determination component 600 to aid location determination component 600 in identifying one or more convenient verification locations for physical verification by entity—either at the time of the incoming transaction or at a later time (e.g., when entity is leaving the business address and going to the home address). For example, if the entity can provide physical verification on the way home from work, location determination component 600 may identify one or more verification locations along a route or at retailers frequented by the entity along the route between the current location of the entity and the home of the entity. In some embodiments, for example, location determination component 600 can identify a gas station often frequented by the entity on the way home from work.

In some embodiments, the entity receives from PC system 102 instructions and/or a request to provide physical verification at a verification location identified by location determination component 600. The entity can provide at the verification location information indicative of the transaction (e.g., barcode for the transaction or other transaction details such as the date, time, merchant, and amount of the transaction).

In some embodiments, the entity may possess the device employed for the transaction and/or any other device that can include functionality for generating a beacon signal that can be detected at a verification location. The beacon signal can include information to identify the transaction of interest for which physical verification is needed. In some embodiments, the device possessed by the entity can be detected by a device at the verification location. The device at the verification location can retrieve and/or cause another device to retrieve information and/or imagery or audio about the entity for verification of the entity. In some embodiments, a device associated with the verification location can transmit a signal/message to the device of the entity informing the entity that a physical verification is requested.

In some embodiments, the entity can interact with a human merchant at the verification location that can visually inspect the entity and/or interact with a device that can scan and/or evaluate one or more aspects of the entity. In some embodiments, the features of the entity evaluated can be compared to one or more features of the entity previously-stored in a database at the verification location and/or accessible over a network from the verification location. In some embodiments, the features of the entity can be compared to one or more features of the entity furnished by the entity via an approved identification (e.g., image in device, driver license, passport or the like).

Memory 610 can be a computer-readable storage medium storing computer-executable instructions and/or information for performing the functions described herein with reference to verification location—time determination component 606 (or a component of verification location—time determination component 606). For example, memory 610 can store computer-executable instructions that can be executed by processor 612 to select a verification location. Data storage 614 can be configured to store information accessed by, received by and/or processed by verification location—time determination component 606.

Referring again to FIG. 4, time—distance evaluation component 408 can evaluate the relative locations and times of purchases by an entity to determine information indicative of whether subsequent purchases should be authorized without physical verification if a first purchase has been authorized with physical verification. In some embodiments, for example, a device initiates a first online shopping attempt at location 1 at time 1. Communication component 400 receives information indicating that the first attempted transaction has undergone successful physical verification at a first verification location. Communication component 400 then receives a subsequent transaction request.

Time—distance evaluation component 409 can evaluate distance and time between the initial transaction that has been physically verified and the location and time of a subsequent transaction. If the location and time of the subsequent transaction are within defined parameters (geographically and/or in time) of the first transaction, time—distance evaluation component 409 can generate a message indicating that PC system 102 should authorize the subsequent transaction. In various embodiments, the accepted distance and difference in time between the transactions can be preset, and/or can be changed from time to time and/or can vary based on the location of the first or second transaction. For example, if the first or second transaction is in an airport or shopping mall, there is a greater expectation that PC system 102 may receive numerous different transactions that are close in time and location based on an entity moving about from one retail store to the next retail store within the airport or shopping mall.

In some embodiments, time—distance evaluation component 409 can tailor the acceptable difference in distance and time to the particular entity or device from which the initial and subsequent transactions originate. As such, the acceptable distance and time between the initial purchase that undergoes successful physical verification and subsequent purchases can vary based on the particular entity. For example, information such as spending habits and/or time—distance spending behavior can be stored in data storage 420 among other information and accessed by time—distance evaluation component 409.

Purchase velocity evaluation component 408 can evaluate the frequency and/or amount of transactions for a particular device (or for a particular entity associated with a device that performs a transaction) to determine information indicative of whether subsequent purchases should be authorized without physical verification if a first purchase has been authorized with physical verification. For example, a particular device (or a particular entity) may be associated with a particular purchase velocity based on previous transactions. The device (or entity) may have a first transaction for which successful physical verification has occurred. The particular device (or entity) may then be associated with one or more subsequent transactions such that the one or more subsequent transactions have a particular purchase velocity. If the purchase velocity of the one or more subsequent transactions indicate a frequency and/or amount of transaction that is aligned with or within an acceptable frequency/amount of the frequency and/or amount of the purchase velocity for the device (or the entity), the one or more subsequent transactions may be approved without additional physical verification. As such, information about the particular device (or entity) purchase velocity can be employed to determine whether a transaction should be authorized without physical verification if a first purchase has been authorized with physical verification

In some embodiments, PC system 102, purchase velocity evaluation component 408 and/or time—distance evaluation component 409 can access a shared risk knowledge database (with reference to FIG. 3, such as a shared risk knowledge database 300, or with reference to FIG. 6, such as the customer or risk database). PC system 102 and/or the one or more other payment processing and/or authorization devices/systems can store and/or access information regarding transactions for a particular entity and/or device associated with a transaction in shared risk knowledge database 300 and/or the customer or risk database.

The information can include the time during which a transaction was performed, whether the transaction was successfully physically verified, the location and/or time of a first transaction that was successfully physically verified, purchase velocity information, times and/or locations of subsequent transactions or the like. For example, once a verification location verifies a particular entity in an airport lounge, if the same card or entity is used in the database in the same lounge as the lounge from an hour ago, or about 40 feet away in the same airport, for example, then time—distance evaluation component 409 can generate information that indicates the subsequent transactions at the airport are given a lower risk level than the risk level allotted by PC system 102 if no previous recent transaction had been physically verified. As such, one or more of the databases can serve as a shared fraud history and transaction information repository.

Verification evaluation component 410 can determine whether physical verification has resulted in a level of risk that is acceptable for authorization of a transaction and/or can output information indicative of acceptance or refusal of a transaction.

Verification location evaluation component 412 can evaluate a verification location that has performed physical verification of an entity. For example, verification location evaluation component 412 can determine whether a verification location has erroneously indicated that a physical verification has been successfully completed by an entity. As another example, verification location evaluation component 412 can determine whether a verification location has erroneously indicated that a physical verification has not been successfully completed by an entity. After a defined number of errors, verification location evaluation component 412 can take additional action including, but not limited to, removing the particular verification location from the set of possible verification locations for use by an entity, reporting to law enforcement (in the case of erroneous reporting of successful physical verification) or any number of other actions.

Reimbursement component 414 can generate reimbursement information for a verification location that has performed the process of attempting physical verification of an entity. In some embodiments, the reimbursement information can be the amount of reimbursement, the verification location and/or merchant identity and/or the time at which the reimbursement should be issued.

In some embodiments, reimbursement component 414 can provide reimbursement generated from one of at least two sources. For example, in one embodiment, the reimbursement for the verification location can be funded by a card network fee. For example, if an entity spends a defined amount of money with a particular merchant (or is attempting to do so via the attempted incoming transaction), reimbursement component 414 can allocate a small fee from the purchase price for the goods or services (or a small fee can be assessed to the merchant). The fee can be provided to the merchant that performs the physical verification as an incentive to continue providing physical verification services. In some embodiments, the fee can vary based on the verification location, the type of verification location, the amount of the transaction or the like.

In another embodiment, on a case-by-case basis, PC system 102 can inform a payment processing device (e.g., payment processing device 106 of FIG. 1) that PC system 102 will reject a transaction unless the physical verification is performed. The payment processing device can provide a fee for the merchant that performs the physical verification.

Memory 416 can be a computer-readable storage medium storing computer-executable instructions and/or information for performing the functions described herein with reference to PC system 102 (or any component of PC system 102). For example, memory 416 can store computer-executable instructions that can be executed by processor 418 to perform communication, evaluation, selection of verification location and time authorized for the physical verification by the entity, acceptance or refusal of a transaction, decision-making or other types of functions executed by PC system 102 (or components of PC system 102). Processor 418 can perform one or more of the functions described herein with reference to PC system 102 (or any component thereof). In some embodiments, processor 418 can evaluate the risk level of or formulate a risk profile for a particular incoming transaction. Processor 418 can determine a location and/or time period for physical verification of a particular transaction. Processor 418 can determine the purchase velocity of a series of transactions and/or determine whether to accept the subsequent transactions after physical verification of the initial transaction. Processor 418 can determine whether the level of risk of an incoming transaction can be suitably mitigated with physical verification prior to the performance/instruction to perform physical verification. Any number of different functions described herein for facilitating operations of PC system 102 can be performed utilizing processor 418.

Data storage 420 can be configured to store information accessed by, received by and/or processed by PC system 102 (or any component of PC system 102). By way of example, but not limitation, data storage 420 can store information such as the locations associated with the workplace, home or other frequently-visited venues by a particular entity. As another example, data storage 420 can store information indicative of contact information for an entity, transactions previously-approved and/or previously-denied for an entity, verification locations to which an entity may be sent to perform physical verification, reimbursement information for a verification location or the like.

Although each of FIGS. 4, 5 and 6 display memory, processor and data storage, in some embodiments, there is a single memory, single processor and/or single data storage employed in lieu of the multiple components shown in FIGS. 4, 5 and 6.

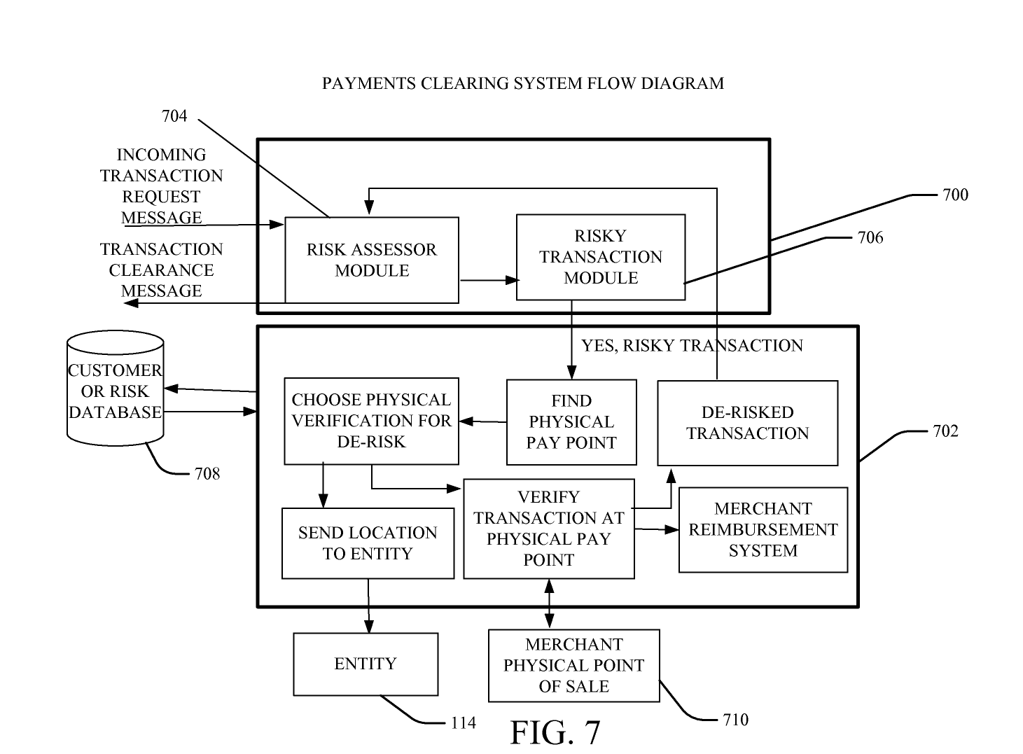

FIG. 7 illustrates an example block diagram of a flow diagram for operations of an example PC system, which may facilitate verification location determination for entity presence confirmation of online purchases in accordance with one or more embodiments described herein. In the embodiment described, the nearest verification location determination is performed. In other embodiments, other verification location determination that is not nearest verification point may be performed and are envisaged herein.

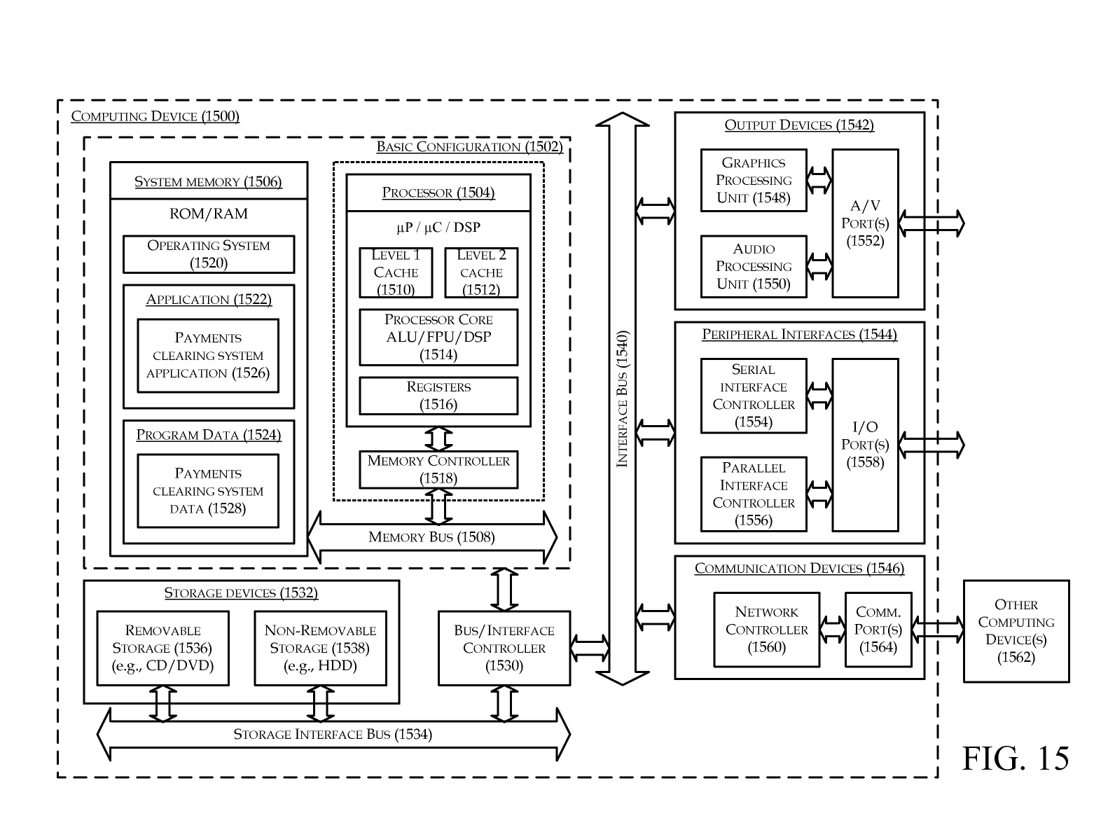

Operations for nearest verification location determination for entity presence confirmation of online purchases are described and shown. The PC system shown includes a mobile payments gateway device 700 and a physical verifier module 702. In various embodiments, one or more of mobile payments gateway 700 and physical verifier module 702 may be electrically and/or communicatively coupled to one another to perform one or more functions of the PC system. As used herein, the term “module” may be or include a device or any other computer nexus. In some embodiments, a “module” may include one or more computing components shown and/or described below with reference with FIG. 15 (e.g., processor 1504).

As shown, an incoming transaction request is received at mobile payments gateway device 700 of the PC system. The incoming transaction request is transmitted from a vendor and/or payment processing device that has received an online purchase request from a device. The incoming transaction request is being transmitted with details of the purchase to mobile gateway device 700 of the payments clearing system to obtain entity presence verification prior to vendor approval of the online purchase. In the embodiments described herein, entity presence verification includes physical presentation of the entity to a third-party that may confirm that the entity has a physical appearance that is aligned with the expected physical appearance of the entity. By way of example, but not limitation, the expected physical appearance may be provided by way of an authorized identification (e.g., state identification card, driver license, passport, electronic approved image stored on mobile device or the like).

As shown in FIG. 7, the incoming transaction request is received at a risk assessor module 704. Risk assessor module 704 may evaluate the incoming transaction request and determine whether the incoming transaction request has a risk profile that indicates that the entity (e.g., entity 114) associated with the device making the request be physically verified. If risk assessor module 704 determines that the transaction has the risk profile that calls for physical verification, risk assessor module 704 transmits information about the transaction to a physical verifier module 702. In some embodiments, one or more of the structure and/or function of physical verifier module 702 can include the structure and/or function of one or more components of payments clearing system 102.

In some embodiments, the transaction information can be transmitted to physical verifier module 702 based solely on receiving the transaction information and the indicator that risk assessor module 704 has determined that the transaction should be physically verified.

In other embodiments, a risky transaction module 706 may determine whether the risk level of the transaction may be mitigated, via physical verification, to a level that would allow approval of the transaction. If the risk level of the transaction cannot be mitigated to a level that would allow the transaction to be approved, risky transaction module 706 may generate a signal indicative of the physical verification being unnecessary, refusing physical verification and/or declining the transaction or providing instructions to decline the transaction. The information may be transmitted to risk assessor module 704 (in some cases, from risky transaction module 706).

Upon receiving information about the transaction, physical verifier module 702 determines a geographical location for physical verification by entity 114. The physical verification may be verification of one or more physical features of entity 114 that initiated the online purchase for which the incoming transaction request was transmitted to the PC system.

In one embodiment, physical verifier module 702 may determine the nearest physical pay point (e.g., merchant physical point of sale 710) to entity 114 at which verification can be performed. The pay point, or as shown in FIG. 7, merchant physical point of sale 710, may be an example of a verification location as described herein. In some embodiments, as shown, physical verifier module 702 may also interact with a customer or risk database (e.g., customer or risk database 708) to choose the specific physical verification location for de-risking (or, reducing the risk of) the transaction. For example, if the payer (e.g., entity 114) has a photo on file with the pay point, the de-risking may be a physically present payment with a verification photo for a merchant at the pay point to review and confirm the payer (e.g., entity 114) as being the actual entity represented on the photo. As described, in some embodiments, the payer is the entity described herein. The physical verification location may then be sent to the payer (e.g., entity 114). A verifier module at physical verifier module 702 may then handle a verified transaction at the physical pay point such as a merchant physical verification location (e.g., merchant physical point of sale 710 of FIG. 7).

In some embodiments, the now de-risked transaction is sent back to mobile payments gateway 700 where the de-risked transaction may be evaluated by risk assessor module 704 again to determine whether the de-risked transaction is now de-risked to a level that is suitable for approval of the incoming transaction request. If the de-risked transaction is approved, risk assessor module 704 generates and transmits a transaction clearance message indicating that the pending (previously risky) transaction, is approved. The transaction may then proceed.

In some embodiments, after verification by physical verifier module 702, the PC system may also include components for reimbursement of the merchant that provides the verification (e.g., the merchant at or associated with merchant physical point of sale 710). For example, as shown in FIG. 7, verification data may be routed to a merchant reimbursement system to credit the merchant who performs the verification (and/or to detect any merchant that routinely verifies transactions as legitimate that are in fact fraudulent transactions).

In some embodiments, the incoming transaction request is authorized or refused based on whether entity 114 has refused physical verification at a particular pay point that is within a particular distance of entity 114, and thus considered to be relatively convenient to entity 114. In some embodiments, the particular distance from the entity can be computed as the distance from the predicted/expected location of the entity during the time period that the physical verifier module 702 has requested that entity 114 perform physical verification.

In this embodiment, the risk profile (or a value for the risk profile) associated with the transaction can be heightened/increased/otherwise indicated as more risky by a refusal of entity 114 to perform physical verification since entity 114 has refused physical verification at a location deemed relatively convenient to entity 114. In this case, the reason that the risk profile (or a value for the risk profile) may be heightened/increased/otherwise indicated as more risky is because refusal to physically verify can be an indicator of attempted fraud by entity 114 and/or attempted fraud by a third-party that may be fraudulently masquerading as entity 114 online.

The particular distance that causes the increase in the risk profile (or the value for the risk profile) can be determined by risk assessor module 704, risky transaction module 706, physical verifier module 702 or any number of other components. In some embodiments, the particular distance can be determined industry-wide by a fraud prevention industry authority. In some embodiments, the particular distance can be determined as a safeguard by the true owner of device 104 and stored as a setting in device 104. In some embodiments, the particular distance can be stored in customer or risk database 704.

In any case, the particular distance can be changed from time to time and/or can be based on time of year (e.g., holiday season, weekends), previous physical verification (or previous refusal of physical verification) by entity 114 or based on any number of other factors (e.g., cost of the transaction). For example, for transactions less than $500, the particular distance may be set to two miles from the location of entity 114 while, for transactions more than $500, the particular distance may be set to five miles from the location of entity 114. For transactions greater than $5,000, the particular distance may be set to 15 miles from the location of entity 114. Thus, in some embodiments, the greater the potential financial loss that could result from a fraudulent transaction, the larger the particular distance that the entity 114 must be willing to travel to avoid an increase to the risk profile (or a value for the risk profile).

In some embodiments, the particular distance can be entity-specific. For example, for one entity, the distance may be two miles while for another entity, the distance may be five miles. As another example, for one entity that may be known to have a car, the particular distance can be a longer distance than another distance that is known to walk to various locations.

As described in the previous embodiments, physical verifier module 702 transmits information about a location for physical verification to entity 114. If entity 114 refuses verification, physical verifier module 702 transmits information indicative of the refusal to risky transaction module 706 and/or risk assessor module 704. Risky transaction module 706 and/or risk assessor module 704 may increase the risk profile of the attempted transaction. In some embodiments, risk assessor module 704 may determine whether to approve the transaction given the increased risk profile. In some embodiments, risk assessor module 704 may refuse to authorize any transaction for which entity 114 has refused physical verification. In some embodiments, risk assessor module 704 may refuse to authorize any transaction for which entity 114 has refused physical verification for verification locations within the particular distance specified for the transaction since the particular distance is considered to be convenient to entity 114.

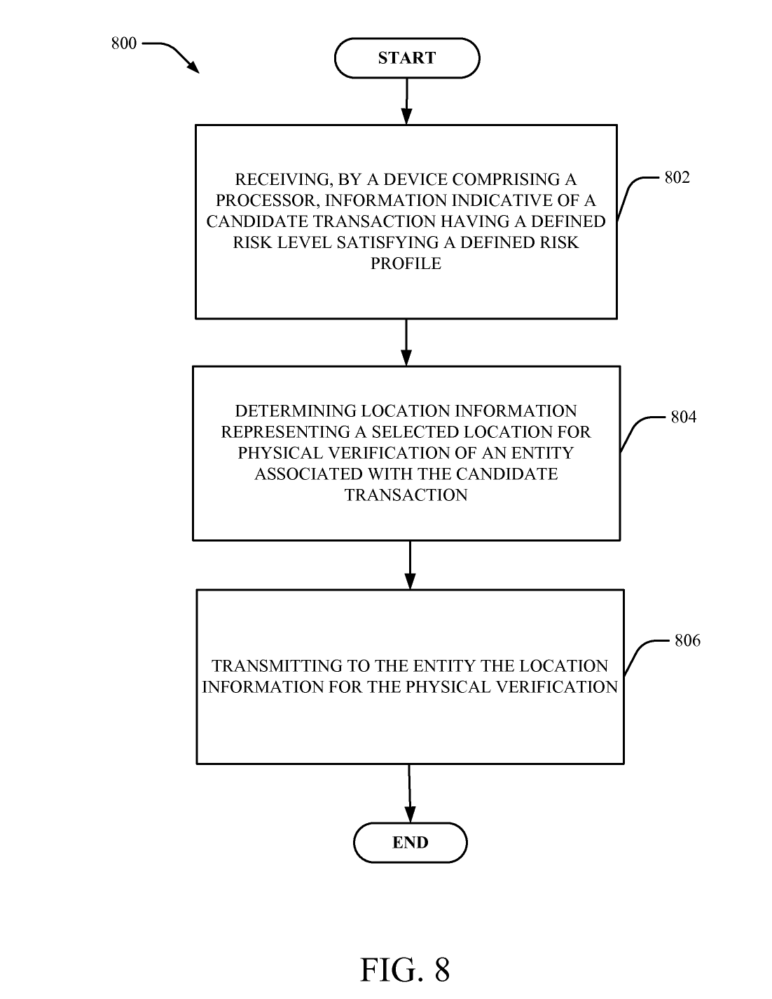

FIGS. 8-14 illustrate example flowcharts of methods associated with verification location determination for entity presence confirmation of online purchases in accordance with one or more embodiments described herein. Turning first to FIG. 8, at 802, a method 800 may include receiving, by a device comprising a processor, information indicative of a candidate transaction having a defined risk level satisfying a defined risk profile. 802 may be followed by 804. At 804, method 800 may include determining location information representing a selected location for physical verification of an entity associated with the candidate transaction. 804 may be followed by 806. At 806, method 800 may include transmitting to the entity (in some embodiments, via an intermediate entity) the location information for the physical verification.

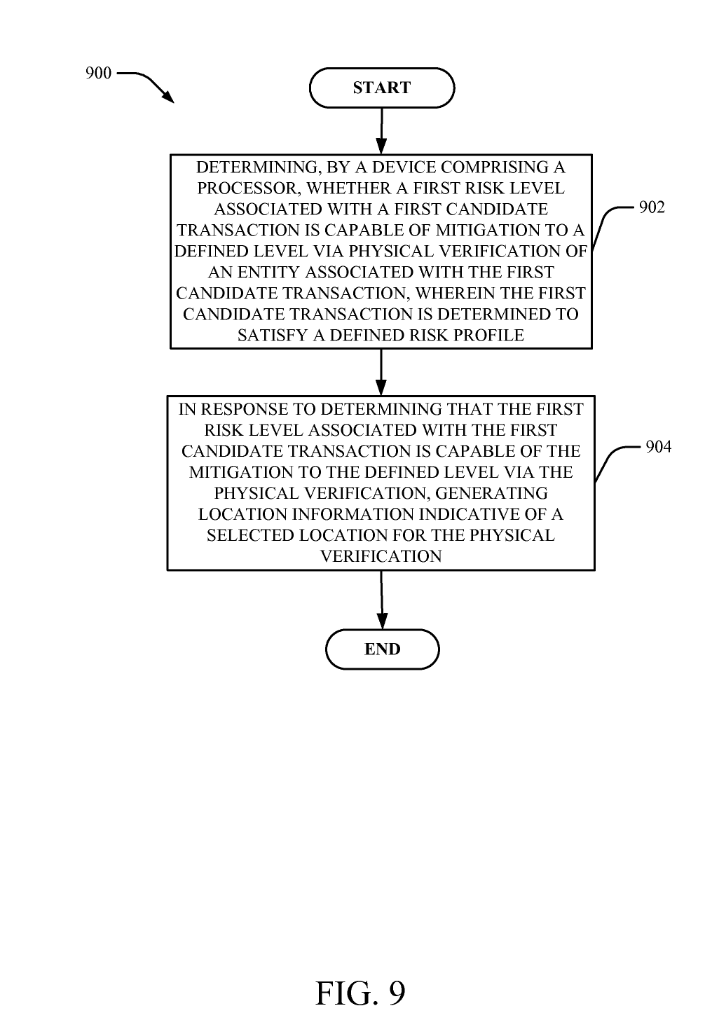

Turning now to FIG. 9, at 902, a method 900 may include determining, by a device comprising a processor, whether a first risk level associated with a first candidate transaction is capable of mitigation to a defined level via physical verification of an entity associated with the first candidate transaction, wherein the first candidate transaction is determined to satisfy a defined risk profile. 902 may be followed by 904. At 904, method 900 may include, in response to determining that the first risk level associated with the first candidate transaction is capable of the mitigation to the defined level via the physical verification, generating location information indicative of a selected location for the physical verification.

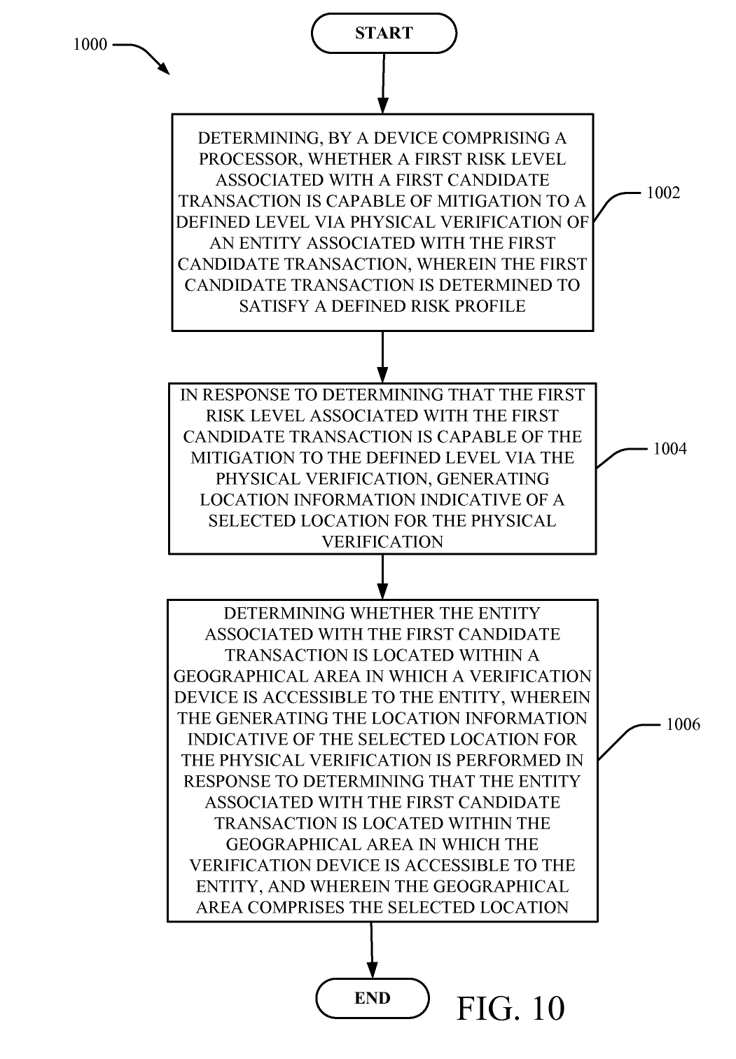

Turning now to FIG. 10, at 1002, a method 1000 may include determining, by a device comprising a processor, whether a first risk level associated with a first candidate transaction is capable of mitigation to a defined level via physical verification of an entity associated with the first candidate transaction, wherein the first candidate transaction is determined to satisfy a defined risk profile. 1002 may be followed by 1004. At 1004, method 1000 may include in response to determining that the first risk level associated with the first candidate transaction is capable of the mitigation to the defined level via the physical verification, generating location information indicative of a selected location for the physical verification. 1004 may be followed by 1006. At 1006, method 1000 may include determining whether the entity associated with the first candidate transaction is located within a geographical area in which a verification device is accessible to the entity, wherein the generating the location information indicative of the selected location for the physical verification is performed in response to determining that the entity associated with the first candidate transaction is located within the geographical area in which the verification device is accessible to the entity, and wherein the geographical area comprises the selected location.

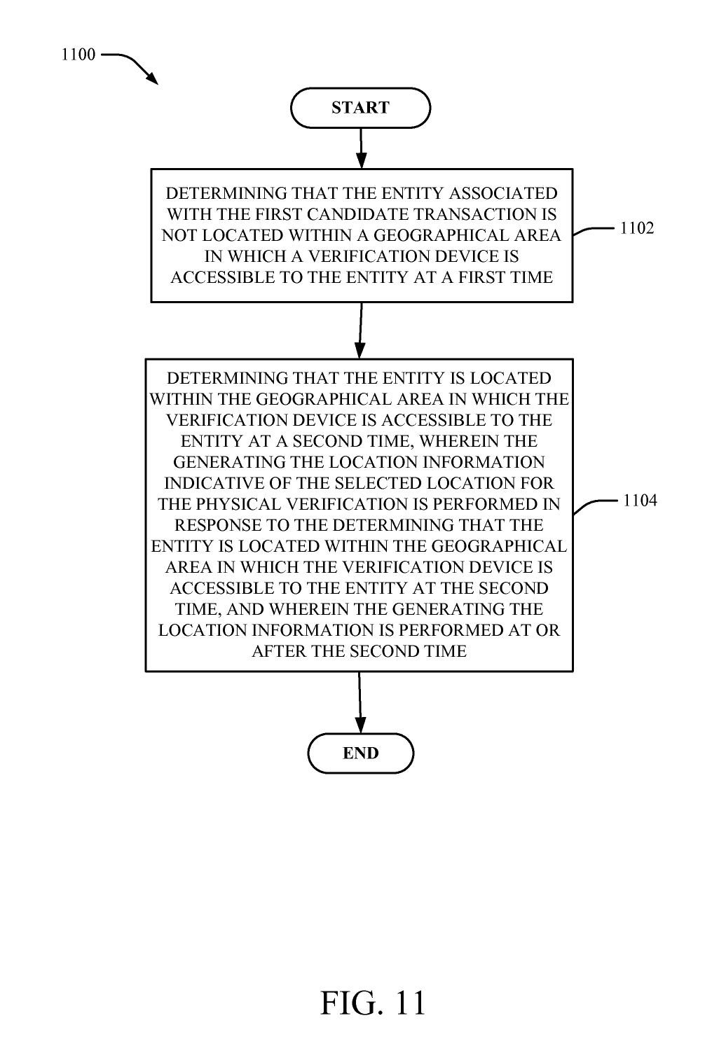

Turning now to FIG. 11, at 1102, a method 1100 may include determining that the entity associated with the first candidate transaction is not located within a geographical area in which a verification device is accessible to the entity at a first time. 1102 may be followed by 1104. At 1104, method 1100 may include determining that the entity is located within the geographical area in which the verification device is accessible to the entity at a second time, wherein the generating the location information indicative of the selected location for the physical verification is performed in response to the determining that the entity is located within the geographical area in which the verification device is accessible to the entity at the second time, and wherein the generating the location information is performed at or after the second time.

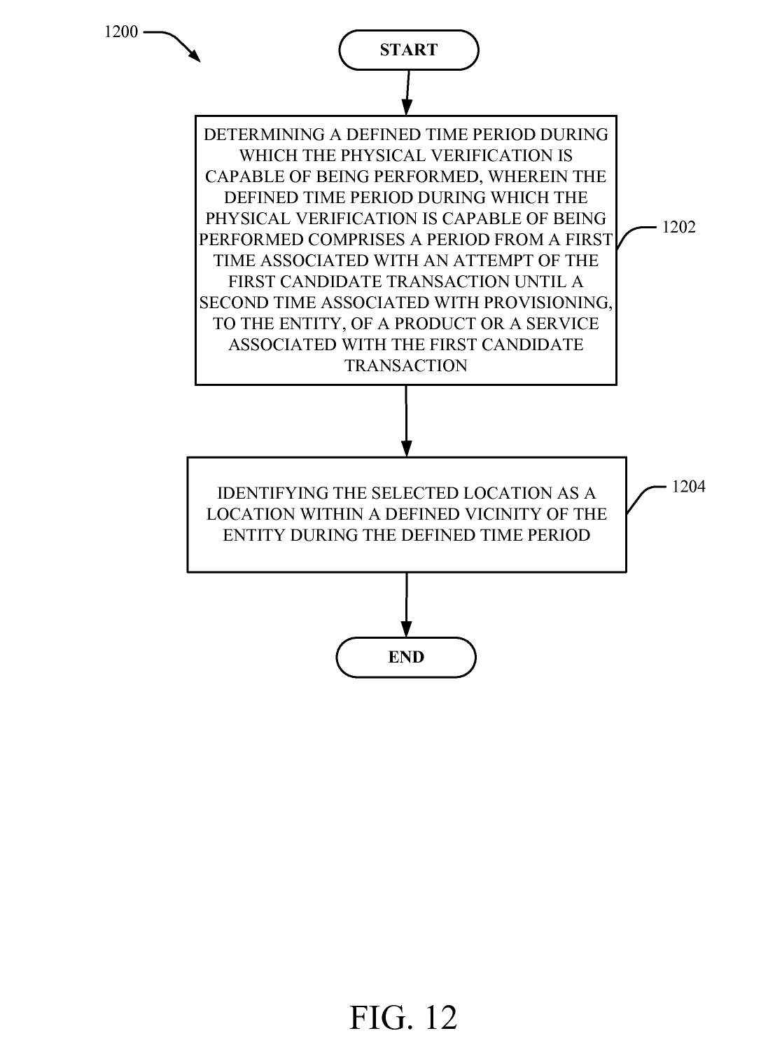

Turning now to FIG. 12, at 1202, a method 1200 may include determining a defined time period during which the physical verification is capable of being performed, wherein the defined time period during which the physical verification is capable of being performed comprises a period from a first time associated with an attempt of the first candidate transaction until a second time associated with provisioning, to the entity, of a product or a service associated with the first candidate transaction. 1202 may be followed by 1204. At 1204, method 1200 may include identifying the selected location as a location within a defined vicinity of the entity during the defined time period.

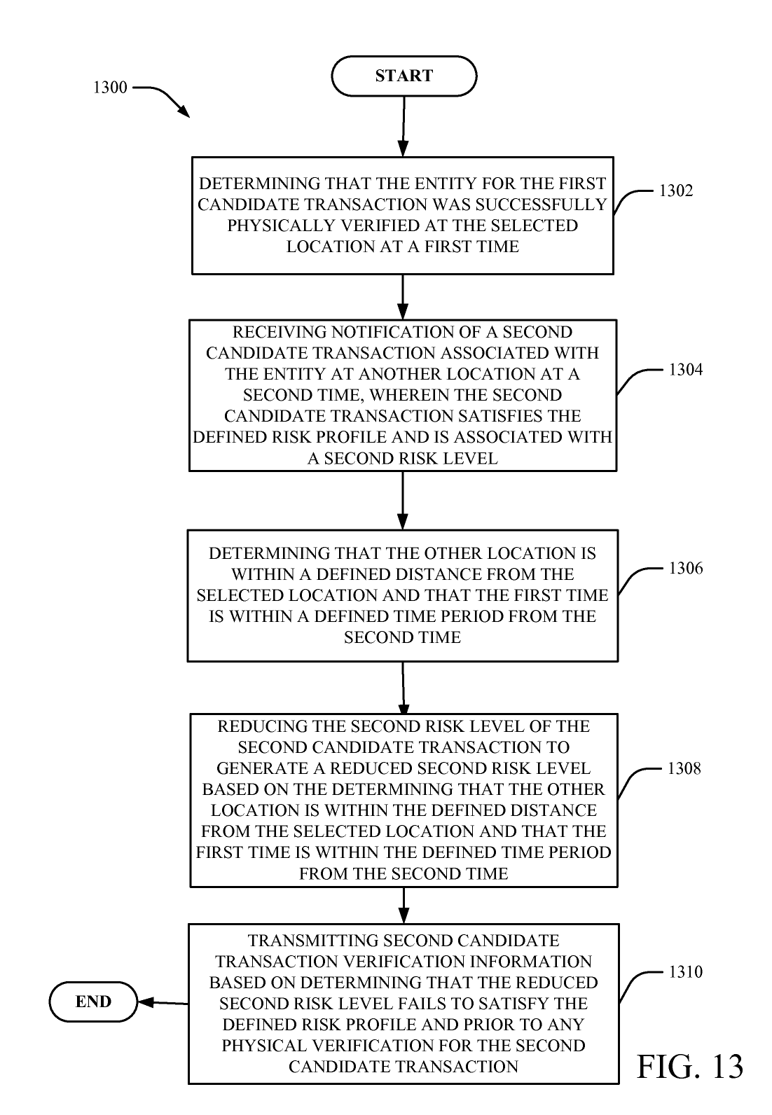

Turning now to FIG. 13, at 1302, a method 1300 may include determining that the entity for the first candidate transaction was successfully physically verified at the selected location at a first time. 1302 may be followed by 1304. At 1304, method 1300 may include receiving notification of a second candidate transaction associated with the entity at another location at a second time, wherein the second candidate transaction satisfies the defined risk profile and is associated with a second risk level. 1304 may be followed by 1306. At 1306, method 1300 may include determining that the other location is within a defined distance from the selected location and that the first time is within a defined time period from the second time. 1306 may be followed by 1308. At 1308, method 1300 may include reducing the second risk level of the second candidate transaction to generate a reduced second risk level based on the determining that the other location is within the defined distance from the selected location and that the first time is within the defined time period from the second time. 1308 may be followed by 1310. At 1310, method 1300 may include transmitting second candidate transaction verification information based on determining that the reduced second risk level fails to satisfy the defined risk profile and prior to any physical verification for the second candidate transaction.

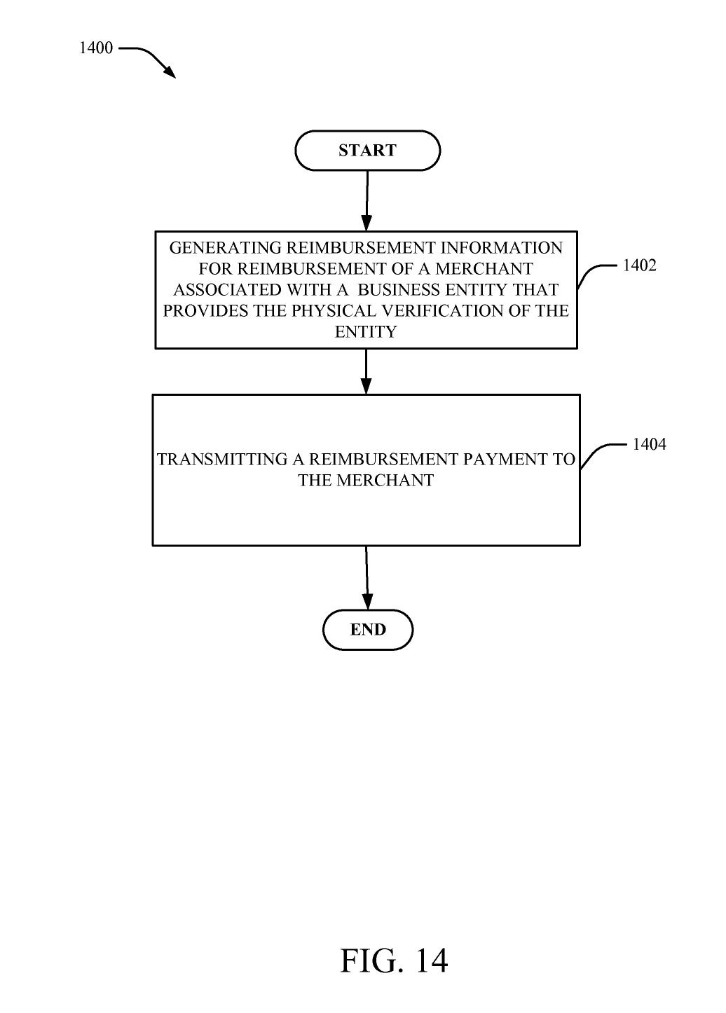

Turning now to FIG. 14, at 1402, a method 1400 may include generating reimbursement information for reimbursement of a merchant associated with a business entity that provides the physical verification of the entity. 1402 may be followed by 1404. At 1404, method 1400 may include transmitting a reimbursement payment to the merchant.

FIG. 15 illustrates an example block diagram of a computing device that is arranged for facilitating verification location determination for entity presence confirmation of online purchases in accordance with one or more embodiments described herein. In some embodiments, the computing device can be or include payments clearing system 102 (or components of payments clearing system 102) (and/or one or more modules described with reference to FIG. 7). For example, the computing device shown in FIG. 15 can be or include structure and/or functionality of verification location—time determination component 406, purchase velocity evaluation component 408, time—distance evaluation component 409, physical verifier module 702 and/or any number of other components/modules/devices described herein. In a very basic configuration 1502, a computing device 1500 typically includes one or more processors 1504 and a system memory 1506. In some embodiments, system memory 1506 may be or include a PC system 102 (or any components of PC system 102). A memory bus 1508 may be used for communicating between a processor 1504 and a system memory 1506.

Depending on the desired configuration, a processor 1504 may be of any type including but not limited to a microprocessor (μP), a microcontroller (μC), a digital signal processor (DSP), or any combination thereof. Processor 1504 may include one more levels of caching, such as a level one cache 1510 and a level two cache 1512, a processor core 1514, and registers 1516. An example processor core 1514 may include an arithmetic logic unit (ALU), a floating point unit (FPU), a digital signal processing (DSP) core, or any combination thereof. An example memory controller 1518 may also be used with processor 1504, or in some implementations a memory controller 1518 may be an internal part of processor 1504.

Depending on the desired configuration, system memory 1506 may be of any type including but not limited to volatile memory (such as RAM), non-volatile memory (such as ROM, flash memory, etc.) or any combination thereof. System memory 1506 may include an operating system 1520, one or more applications 1522 (e.g., payments clearing system application 1526), and program data 1524 (e.g., payments clearing system data 1528). For example, the payments clearing system application 1526 can be or include one or more applications that can cause the computing device of FIG. 15 to perform services associated with payments clearing system 102. Payments clearing system data 1528 can be or include data (e.g., transaction information, verification location information) employed by payments clearing system 102 to perform services associated with payments clearing system 102. In some embodiments, computing device 1500 may be or be included in PC system 102 (or one or more components of PC system 102). In some embodiments, an application 1522 may be arranged to operate with program data 1524 on an operating system 1520 such that entity presence verification of online purchases may be performed as described herein. This described basic configuration 1502 is illustrated in FIG. 15 by those components within the inner dashed line.

Computing device 1500 may have additional features or functionality, and additional interfaces to facilitate communications between basic configuration 1502 and any required devices and interfaces. For example, a bus/interface controller 1530 may be used to facilitate communications between basic configuration 1502 and one or more data storage devices 1532 via a storage interface bus 1534. Data storage devices 1532 may be removable storage devices 1536, non-removable storage devices 1538, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 1506, removable storage devices 1536 and non-removable storage devices 1538 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 1500. Any such computer storage media may be part of computing device 1500.

Computing device 1500 may also include an interface bus 1540 for facilitating communication from various interface devices (e.g., output devices 1542, peripheral interfaces 1544, and communication devices 1546) to basic configuration 1502 via a bus/interface controller 1530. Example output devices 1542 include a graphics processing unit 1548 and an audio processing unit 1550, which may be configured to communicate to various external devices such as a display or speakers via one or more A/V ports 1552. Example peripheral interfaces 1544 include a serial interface controller 1554 or a parallel interface controller 1556, which may be configured to communicate with external devices such as input devices (e.g., keyboard, mouse, pen, voice input device, touch input device, etc.) or other peripheral devices (e.g., printer, scanner, etc.) via one or more I/O ports 1558. An example communication device 1546 includes a network controller 1560, which may be arranged to facilitate communications with one or more other computing devices 1562 over a network communication link via one or more communication ports 1564.

Computing device 1500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1500 may also be implemented as a personal computer including both laptop computer and non-laptop computer configurations.

A network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The use of hardware or software may be generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems. A typical data processing system can be implemented utilizing any suitable commercially available components, such as those typically found in data computing/communication and/or network computing/communication systems.

The herein described subject matter sometimes illustrates different components contained within, or connected with, different other components. Such depicted architectures are merely examples, and many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described in this application, which are intended as illustrations of various aspects. Many modifications and variations can be made without departing from its spirit and scope. Functionally equivalent methods and devices within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, computer-readable storage devices, systems or apparatus disclosed, which can, of course, vary. The terminology used herein is for the purpose of describing particular embodiments only, and is not intended to be limiting.

What is claimed is:

1. A method, comprising:
determining, by a device comprising a processor, whether a first risk level associated with a first candidate transaction is capable of mitigation to a defined level via physical verification of an entity associated with the first candidate transaction, wherein the first candidate transaction is determined to satisfy a defined risk profile; and
in response to determining that the first risk level associated with the first candidate transaction is capable of the mitigation to the defined level via the physical verification, generating location information indicative of a selected location for the physical verification.

2. The method of claim 1, further comprising:
determining, by the device, that the first candidate transaction satisfies the defined risk profile.

3. The method of claim 1, further comprising:
determining whether the entity associated with the first candidate transaction is located within a geographical area in which a verification device is accessible to the entity, wherein the generating the location information indicative of the selected location for the physical verification is performed in response to determining that the entity associated with the first candidate transaction is located within the geographical area in which the verification device is accessible to the entity, and wherein the geographical area comprises the selected location.

4. The method of claim 1, further comprising:
determining that the entity associated with the first candidate transaction is not located within a geographical area in which a verification device is accessible to the entity at a first time; and
determining that the entity is located within the geographical area in which the verification device is accessible to the entity at a second time, wherein the generating the location information indicative of the selected location for the physical verification is performed in response to the determining that the entity is located within the geographical area in which the verification device is accessible to the entity at the second time, and wherein the generating the location information is performed at or after the second time.

5. The method of claim 1, further comprising:
determining a defined time period during which the physical verification is capable of being performed; and
identifying the selected location as a location within a defined vicinity of the entity during the defined time period.

6. The method of claim 1, further comprising:
transmitting, to the entity, the location information indicative of the selected location for the physical verification based on a determination that the entity is within a defined vicinity of the selected location.

7. The method of claim 5, wherein the defined time period during which the physical verification is capable of being performed comprises a period from a first time associated with an attempt of the first candidate transaction until a second time associated with provisioning, to the entity, of a product or a service associated with the first candidate transaction.

8. The method of claim 1, wherein the location information indicative of the selected location for the physical verification is generated based on biographical information associated with at least one of a first location of a business address of the entity, a second location of a residential address of the entity or a third location of a business previously visited by the entity.

9. The method of claim 1, further comprising:
in response to determining that the first risk level associated with the first candidate transaction cannot be mitigated to the defined risk level via the physical verification,
failing to generate the location information indicative of the selected location for the physical verification, and
generating transaction refusal information indicative of a declination of the first candidate transaction.

10. The method of claim 1, wherein the physical verification comprises verification of at least an in-person physiological aspect of the entity and an identifier of the first candidate transaction.

11. The method of claim 10, wherein the identifier of the first candidate transaction is included in a signal emitted from an electronic device associated with the entity.

12. The method of claim 1, further comprising:
generating first candidate transaction verification information indicative of a received notification of a successful physical verification of the first candidate transaction.

13. The method of claim 12, wherein the first candidate transaction verification information comprises information descriptive of the first candidate transaction and information indicative of a successful verification of the first candidate transaction.

14. The method of claim 1, further comprising:
determining that the entity for the first candidate transaction was successfully physically verified at the selected location at a first time;
receiving notification of a second candidate transaction associated with the entity at another location at a second time, wherein the second candidate transaction satisfies the defined risk profile and is associated with a second risk level;
determining that the other location is within a defined distance from the selected location and that the first time is within a defined time period from the second time; and
reducing the second risk level of the second candidate transaction to generate a reduced second risk level based on the determining that the other location is within the defined distance from the selected location and that the first time is within the defined time period from the second time.

15. The method of claim 14, further comprising:
transmitting second candidate transaction verification information based on determining that the reduced second risk level fails to satisfy the defined risk profile and prior to any physical verification for the second candidate transaction.

16. The method of claim 1, further comprising:
generating reimbursement information for reimbursement of a merchant associated with a business entity that provides the physical verification of the entity.

17. The method of claim 1, further comprising:
transmitting the selected location for the physical verification to the entity; and
identifying a business entity at which the physical verification is performed that verifies the first candidate transaction, wherein the first candidate transaction is determined to be a fraudulent transaction.

18. A computer-readable storage device storing executable instructions that, in response to execution, cause a device comprising a processor to perform operations, comprising:
receiving information indicative of a candidate transaction having a defined risk level satisfying a defined risk profile;
determining location information representing a selected location for physical verification of an entity associated with the candidate transaction; and
transmitting, to the entity, the location information for the physical verification.

19. The computer-readable storage device of claim 18, wherein the operations further comprise:
reducing the defined risk level of the candidate transaction based on determining that the entity has been successfully physically verified at the selected location.

20. A method, comprising:
receiving, by a device comprising a processor, information indicative of a candidate transaction having a defined risk level satisfying a defined risk profile;
determining location information representing a selected location for physical verification of an entity associated with the candidate transaction; and
transmitting to the entity the location information for the physical verification.
